(19) United States
(12) Patent Application Publication
(10) Pub. No.: US 2021/0348929 A1
(43) Pub. Date: Nov. 11, 2021

(54) System for Route Management According to Policies Related Applications

(71) Applicant: Eleos Technologies, LLC, Greenville, SC (US)

(72) Inventor: Kevin Survance, Greenville, SC (US)

(73) Assignee: Eleos Technologies, LLC, Greenville, SC (US)

(21) Appl. No.: 17/151,195

(22) Filed: Jan. 17, 2021

Related U.S. Application Data
(60) Provisional application No. 63/022,012, filed on May 8, 2020.

(51) Int. Cl. G01C 21/34; G01C 21/36

(52) U.S. Cl. CPC G01C 21/3415; G01C 21/3453; G01C 21/3605; G01C 21/3694

(57) ABSTRACT

This system is for trip management having a route system in communications with a dispatch system and user device. A set of route computer readable instructions can be configured for: receiving trip information from a dispatch computer system including an origin, target and policy wherein the policy is taken from the group consisting of maximum miles, maximum toll cost, earliest arrival time, latest arrival time, target location information, and any combination thereof. The system can calculate a route between the origin and target so that a policy violation, creating a trip plan according to the trip information and the route, receiving a proposed trip plan modification, determining if the proposed trip plan modification results in a second policy violation, transmitting a policy violation alert to the user computer device if the second policy violation is determined, receiving a second policy violation mute request, and, muting the second policy violation alert.

### RELATED APPLICATIONS

This application claims priority on U.S. Provisional Patent Application No. 63/022,012 filed on May 8, 2020 which is incorporated by reference.

### BACKGROUND OF THE INVENTION

### 1) Field of the Invention

This system is directed to the management, creation, analysis, display and/or sharing of routes and deviations about an initial route target location by users who visit such physical locations including when target location information is stored in multiple, unconnected computer systems with disparate data formats and varying levels of data detail.

### 2) Description of the Related Art

Travelers, workers, or others that travel or send others including sending vehicle and articles (e.g., personnel, vehicles, materials, goods, inventory, supplies, and equipment) to specific locations have long struggled to maintain accurate information about the target locations. Entities often use different versions of target location information that is used in association within their internal systems computerized or otherwise. Some of the information that is maintained about a target location include the target location name, geographic coordinates (that can be latitude and longitude), the address or location of an entry/regress target location, preferred routes, alternate routes, available amenities, hours of service, special considerations for driving to, dwelling at, and exiting the business location and the like.

Further, once a route is determined between an origination point and target locations, it can be advantageous to make modifications to that route due to intervening circumstances or other factors. For example, road construction, weather, the addition or removal of stops, mechanical issues, and the like may require modifications to the trip or route. Routes are also designed with performance attributes to further the objectives of safety, profit, timeliness, and customer service. When a route is modified, it is desirable for the modifications not to negatively affect the performance attributes. For example, if a trip is designed to be 500 miles, the profitability of the trip is negatively affected if the route causes the trip to exceed 500 miles, for example, by increasing fuel consumption and therefore costs. It would be advantageous to have a system that would allow proposed modifications to a trip plan made prior to the actual modification of the trip plan to see the impact of the modifications to the performance attributes so that safety, profitability, timeliness and customer service are not diminished by the modifications. It would also be advantageous to provide for a user to enter proposed modifications before the trip begins or mid-trip and have the user see the effect of such modifications prior to actually modifying the trip.

One of the changes that can occur is the target location criteria. For example, target location criteria can include a delivery location, security procedure, entrance procedure, entrance date and time, delivery window, and others and can change according to the target location management and others. It would also be advantageous to have a system that enables travelers dispatched to a target location to update the target location information based upon information gathered before the route begins, during the route, and when exiting the target location and to be able to share the data with other entities dispatched to the same location.

In determining the effect of a trip or route modifications, it can be challenging to have sufficient information to determine the effect on the trip or route. With disparate systems and data, gathering information and easily sharing information about trips, routes, origins, target locations it can be challenging because of the disparities in how the data is stored in multiple systems. This results in inefficiencies that include redundant efforts to retrieve data in a single or shared system that can be used to analyze trips and trip modifications. Further, having individual systems collecting and determining trips or routes can result in outdated data, inconsistent data and data that does not accurately reflect the physical characteristics or current states of the item or circumstance associated with the data. Further, the inability to aggregate data and share data among different entities can lead to duplication of work, increased inefficiencies, and unnecessarily wasted time and resources.

There have been some attempts to coordinate travel to a common destination and share information, but these attempts are focused on the travel path rather than the attributes that are associated with a trip or target location such as is shown in United States Patent Publication 2017/0067747. U.S. Pat. No. 7,711,587 discloses a system and techniques for presenting travel information to a user that includes predetermined travel parameters specified by the user. A travel query is populated with the predetermined travel parameters and a variable parameter based on identification information associated with the user. Cached travel options that are obtained from prior queries and that satisfy the travel query are presented to the user. Route information has been attempted to be efficiently provided to travelers as shown in United States Patent Publication 2007/0106465. However, none of these attempts provide for a system that provides updated, sharable, attributes associated with the trip or trip plan. Further, none of these prior attempts provide for a system that provides updated, sharable attributes associated with the trip. Further, none of these prior attempts provide for a system that provides for target location information based upon information specific to the target location that can be useful when traveling to, dwelling at and exiting from the target location.

Entities who send personnel, vehicles and equipment (e.g., users) on trips to transport goods and perform work at remote locations have long struggled to monitor the trips as they are modified, even during the route. This monitoring and management can be disruptive and have a negative impact on policies and parameters for the trip or route, regulations, laws, practices, safety, efficiency, timeliness, operations, customer services and profitability (e.g., performance attributes). When something happens that causes a trip to fail the originator's requirements, originators can lack a robust failure alert mechanism and a system for viewing and assessing the trip and the related acts, omissions, or violations of the originator's requirements in order to assess the situation and take remedial action.

It would be advantageous to have a system that allows for defined trip plan requirements (e.g., “policies”), provides a service for monitoring the trip plan with respect to the policies throughout the duration of the trip and recognize and report a policy violation, provide an alert in response to a proposed trip modification to determine if the proposed modification is consistent with the performance attributes and/or policies, provide an alert so the originator can adjust the trip plan or ignore the policies to allow the proposed modifications to be accepted.

Therefore, it is an object of the present invention to provide a system that designs an initial trip, including a route, receives policies according to performance attributes, receives proposed modifications to the trip or route and determines if the proposed modifications result in a policy violation.

### BRIEF SUMMARY OF THE INVENTION

The above objectives are accomplished by providing a computerized system for trip management comprising: a route system having a computer readable medium and in communications with a dispatcher computer system and a user computer device; and, a set at route computer readable instructions included in the route system configured for: receiving trip information from a dispatch computer system including an origin, target location and a policy wherein the policy is taken from the group that can include maximum miles, maximum toll cost, earliest arrival time, latest arrival time, target location information, and any combination thereof, calculating a route between the origin and target location according to the policy so that a first policy violation is not present, creating a trip plan according to the trip information and the route, receiving a proposed trip plan modification, determining if the proposed trip plan modification results in a second policy violation, transmitting a policy violation alert to the user computer device if the second policy violation is determined, receiving a second policy violation mute request, and, muting the second policy violation alert,

The system can be in communication with a third-party computer system and the set of route computer readable instructions included instructions can be configured for creating a trip plan configured to be displayed on a map generated by the third-party computer system. The set of route computer readable instructions can include instructions configured for receiving a user location from the user computer device, comparing the user location with the trip plan, and, determining if there is a deviation from the trip plan. The computer readable instructions can include instructions configured for determining if the deviation creates a deviation policy violation. The set of route computer readable instructions can include instructions configured for transmitting the deviation policy violation to one of the route systems, the dispatcher computer system, and any combination thereof. The set of route computer readable instructions can include instructions configured for receiving the proposed trip plan modification from the user computer device. The set of route computer readable instructions can include instructions configured for transmitting the trip plan to the user computer device. The set of route computer readable instructions can include instructions configured for receiving a trip plan approval prior to sending the trip plan to the user computer device. The set of route computer readable instructions can include instructions configured for receiving the trip pan approval from the dispatch computer system. The set of route computer readable instructions can include instructions configured for creating the trip plan according to a prior trip plan having a same target location. The set of route computer readable instructions can include instructions configured for creating the trip plan according to a prior trip plan having a same target location as the prior trip plan. The set of route computer readable instructions can include instructions configured for receiving a mute reason when the second policy violation alert is muted. The set of route computer readable instructions can include instructions configured for determining a status of the second policy violation.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a flow chart of aspects of the system;

FIG. 2 is a schematic of aspects of the system;

FIG. 3 is a schematic of aspects of the system;

FIG. 4 is a schematic of aspects of the system;

FIG. 5 is a flowchart of aspects of the system;

FIG. 6 is a schematic of aspects of the system;

FIG. 7A is a flowchart of aspects of the system; and,

FIG. 7B is a flowchart of aspects of the system.

### DETAILED DESCRIPTION OF THE INVENTION

With reference to the drawings, the invention will now be described in more detail. As used in this specification, the “user” includes a human being, an autonomous vehicle, autonomous machine, a remotely controlled vehicle or machine and any combination thereof.

A “target location” includes any destination where a user wishes to travel or visit, including businesses, real property, vacation destinations, residences, developed and undeveloped land, military locations (e.g., operating bases), and any combination. A trip plan and its digital representation can include the travel time, load, route, and other attributes.

An “operator” can be the dispatcher directing a user to a target location and can be positioned locally to the departure locations, remotely from the departure location and can be in electronic communications with the user.

A “trip plan” can include an origination, intermediate stops, target or destination, route, policies, attributes, requirements, and other items associated with a trip.

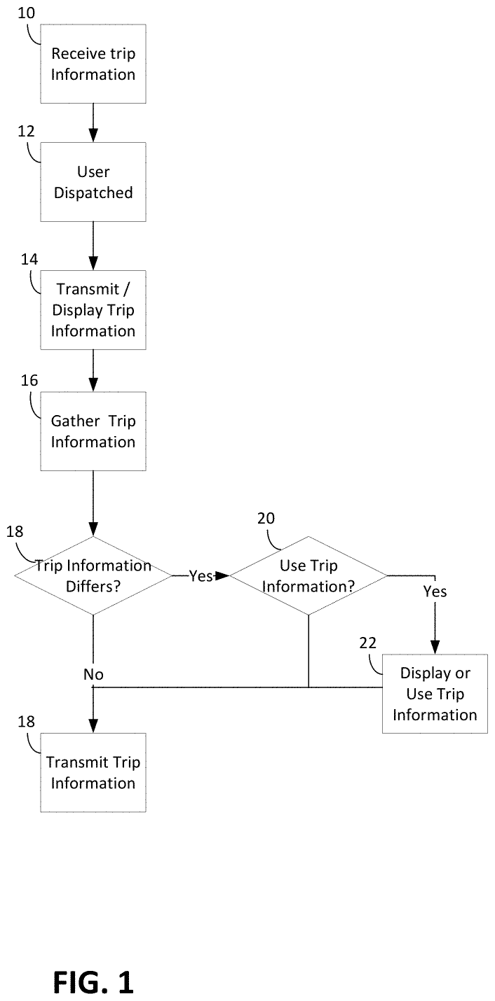

Referring to FIG. 1, a trip plan can be generated by a system associated with a dispatcher (e.g., company, individual, emergency response organization, travel facilitator, tour guide, etc.). The system can receive information from a customer and generate a trip plan. The trip plan can be reviewed or modified prior to being transmitted to the customers or user. In one embodiment, the trip plan can be originally created and displayed to a user. The user can then make modifications and the results of the modifications can be seen. The results can include changes to the trip plan attributes, alerts that are generated, changes to the routes and other aspects of the trip plan.

The system can be a combination of local or remote computer hardware that includes system computer readable instructions for providing the function and structure described herein. The system can include one or more servers on a local area network, wide area network, global area network and any combination thereof. Each customer using the system can have computer readable instructions running on the system or the customer's server. The system can access the customer server to receive and transmit data. The system can aggregate data from various remote system including customer computer systems and third-party computer systems.

The trip plan can be sent to a user computer device at 10. The user computer device can be associated with the user, with a vehicle, or both. In some cases, such as when the user is an autonomous vehicle, the user computer device can be integrated with or into the user. The system can receive policies that serve as parameters to the trip plan, an origination and target location. The system can calculate a route that can be included in a trip plan that is consistent with the policies and send the route and/or trip plan to the user computer device. The user computer device can be remote from the system so that the user is provided with trip and route information.

The user can be dispatched from the origin to a target location at 12. The user can be dispatched to a target location where some activity is associated with the target location such as a delivery, pick-up, installation, repair, inspection, emergency response, activity (e.g., vacation, sport event, meeting) and the like. The user can review the trip plan and its information concerning the load or route so that the user is provided with instructions for performing the trip plan.

The target location can be displayed or transmitted to the user computer device and display load information, map, route, waypoints, pins, entry points, entry requirements, security requirements and other information at 14 associated with the trip plan including activity associated with the target location. The user computer system can receive trip information that can be integrated with a mapping system on the user computer system or retrieved from a third-party system. For example, the user computer system can access a third-party mapping system and display route information from the trip plan on the third-party mapping system to provide the user with a route in relation to a third-party map.

The target location information can include instructions and information such as navigation to the target location, entrance information, access information, security, needed documentation and other attributes and policies associated with the trip, route or target location and navigate away from the target location.

When the user is in route to or from the target location and interacts or performs tasks during the trip including when at the target location, the user computer device can gather and record information at 16. Such gathered information can include arrival routes, entrances, onsite resource locations, amenities, egress locations, and departure routes. The user's computer readable instructions can include instructions for assessing the gathered target location information and determining if the gathered target location information differs from the provided target location information or the trip plan at 18, determine whether to utilize any of the gathered target location information at 20, which set of target location information to use, display or provide recommendations or actions based upon the gathered target location (e.g., if the actual entrance location differs from the provided entrance location) at 22. The gathered information can be received by the user's computer readable instructions adapted for use by the user computer device which can be transmitted to the system at 24. When the user interacts with a target location that has existing data associated with the target location, the existing target location information previously gathered by other users can be shared with the current user as a recommendation (e.g., use an alternate entrance location, security requires ID, delivery locations, etc.). The user can then decide to use the recommended target location information when interacting with the target location. The user can also select or modify the route or target information as necessary upon arrival at the target location.

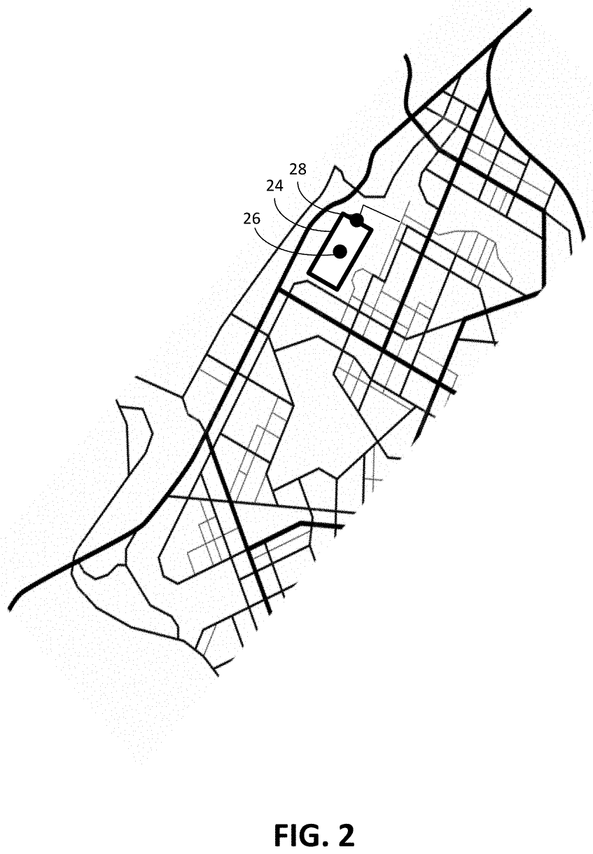

Referring to FIG. 2, a user may initially be provided with the address of the target location. A map can be displayed for the user illustrating the address. If the map illustrates the address without a relationship to the physical structure, the address can be displaced in relationship to the map. Target location 24 can show an address marked 26 that coincides with the center of a building. This creates a challenge for the user in that the address is not displayed in relation to the physical structure, such as entry point, gate and the like and is based upon the physical address alone. This situation can occur when third-party information is used to place the target location on the display. In this situation, the user may discover that the user needs to arrive at a different location 28 and can input this location on the user computer device. This information can be returned to the system so that a record of the user's decision to alter the trip plan (e.g., route and/or target location information) can be received, stored and shared with other users or otherwise subsequently used.

Further, target location information can be entered into the system and matched with the system's target location information. The target location can also be matched with target location information from other sources. The target location information from other sources can be from other party dispatches and/or preexisting datasets. For example, the target location can initially be displayed using information from a third-party provided such as Google Maps, MapQuest, Rand McNally, OpenStreetMap and others. When the user arrives at the location, the user computer device can record the target location based upon the physical location of the user and this information can be provided to the system. The system can then update the location associated with the target location so that a subsequent trip plan can include the updated address. The system can then associate the target location information with the physical target itself. The system's computer readable instructions can use heuristics to provide expanded target location information to the user and to offer recommendations regarding the target location to the user based upon the collection of a dataset associated with the target location.

If the user decides to follow a recommendation based upon received target location information, these actions can be received by the user computer device and transmitted to the system for storage and subsequent use. Therefore, the computer readable instructions can provide recommendations on the existing and current target location information and the acts or omission of the user interacting with the target location. When a user acts or omits an action, the target location information associated with that act or omission can be transmitted to the system and the existing target location information can be updated, stored, or shared accordingly. Furthermore, the system may use the act or omissions to enhance the current operating procedures and to provide higher quality, more accurate and current target location information validated by the user.

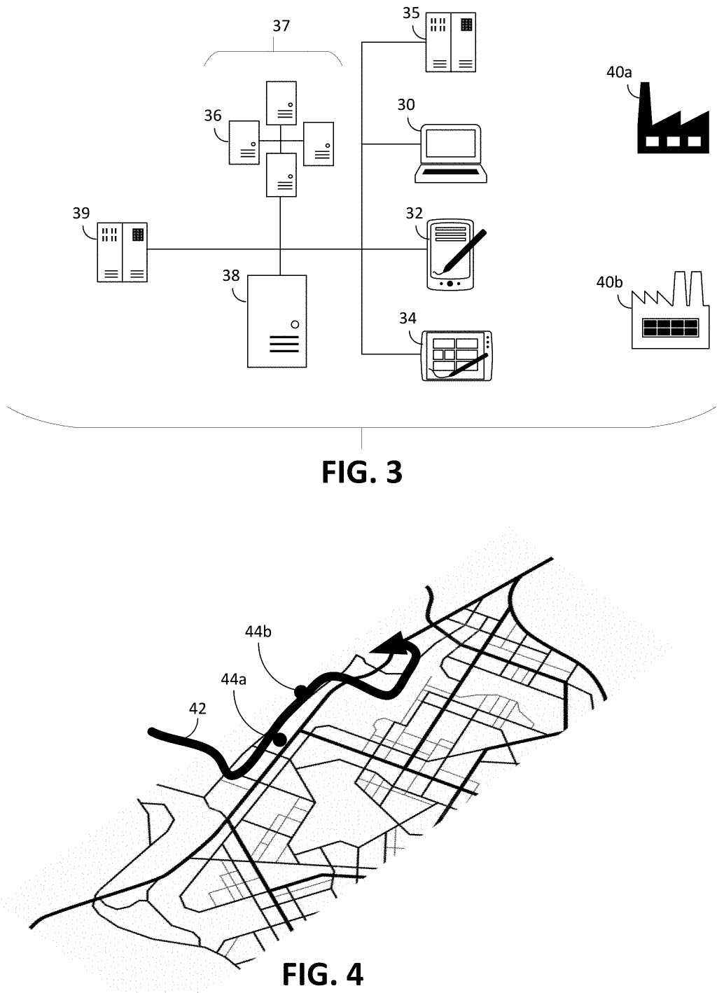

Referring to FIG. 3, the user computer device can be any number of computer devices including a laptop 30, smart phone 32, tablet 34, proprietary user computer device and any combination. The system can be a route system and can be in communications with a dispatch computer system that can be associated with a customer. The dispatch computer system can be in communications with the user computer device so that information can flow from the user computer device to the dispatch computer system to the route system. The system 37 can include one or more remote servers 36 or one or more local servers 38. The system can access third-party computer systems 39 such as inventory management systems, accounting systems, logistics systems, facilities management systems, enterprise resource planning systems, mapping systems, location systems, including real time location systems, global positioning systems, tracking systems and any combination. The system can be in communications with a dispatching system so that trip information and trip plans can be transmitted between the two systems. A first server in the system can be accessed by a first set of users so that when information from one of the first set of users is sent to the system, that information can remain localized to that first server. Therefore, multiple parties can have servers without necessarily having to share user information throughout the entire system. The system can be in communications with one or more distributor servers and/or users. The system can transmit information to the servers so that the information from one or more servers can be aggregated and communicated to multiple users or servers. The users can receive and enter information for transmission to the system concerning the target location 40a and/or 40b.

For example, a first customer can use a first server with a first set of user information. This first server can receive trip plan information and generate a first route for a first user. The first route would include a first target destination that can be of a first client of the first customer. The first customer may not wish to have this information shared with another entity. Therefore, a second customer can have its trip information on a second server that can be independent from the first server so that the first customer is not provided access to the second server information. The system can access both servers and can aggregate information without necessarily sharing information between the first and second customer. In one embodiment, when the system determines that the second customer has selected the same target location as the first customer, the system can provide the second customer with updated target location information due to the fact that both the first customer and the second customer have a need to have a trip plan to the same target location. Neither customer would necessarily be allowed to search the others trip plan information or receive trip plan information unless the trip plan information, such as the target location, was known to both customers independently.

One example of a system for providing the structure and function described herein, can include a system that can be in communications with one or more servers and the user computer device. The user computer device can include user computer readable information adapted to provide the functionality described herein. The system can send a trip plan to the customers server using any number of methods including an application program interface.

In one embodiment, the user, when reviewing a trip plan, can benefit from information of prior users, prior travel, or prior trip plan activity. For example, the user can be presented with aggregation information such as XX % user route A in the past, YY % deviated from the existing route, ZZ % modified the route and the like. When the user makes a decision based upon the received information, the user's decision can be sent to the system and included in the information associated with that trip plan.

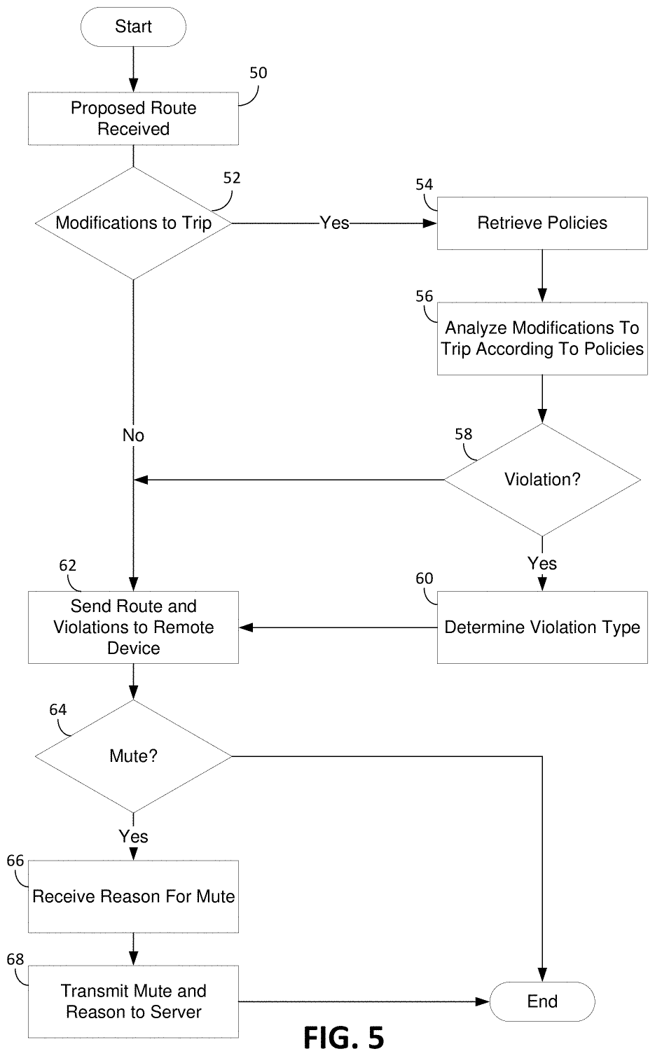

Referring to FIG. 4, the system can also include a trip plan 42 that can include load information, origination information, target location information, and include a sequence of intermediary stops 44a and 44b between the origination and target location. The trip plan can include navigation (e.g., legs) from stop to stop during the trip. For example, the trip plan can include a first target location and a second target location. For example, if the trip plan includes an origin, a pickup, a first delivery and a second delivery, the first target location can be the pickup location, the second target location can be the first delivery and the third target location can be the second delivery location. The trip plan can contain information regarding appointment times, work orders, items to deliver, contact information, special instructions, target location information, load information, etc. A trip plan can evolve over time as the user executes the trip plan or the trip plan is modified. In one embodiment, when the system is provided an origination and destination, the system can generate a route according to the origination, destination, performance attributes, policies, data from third-party databases, including traffic, load information, and other trip information. Performance attributes and policies can include maximum miles in route, maximum toll cost, maximum elevation, arrival time or arrival time window, departure time or departure time window and any combination. Policies can include a unique identification, alphanumeric description, and administrative description.

The system can send the user a trip plan that can be displayed on the user computer device prior to or contemporaneously with dispatching the user. The trip plan can be displayed and can include a list of stops where one or more stops can be a target location. Each target location can be associated with detailed information about the target location and the task to be performed at the target location. A map displaying a route to navigate to each target location can be provided. The user's computer system can track the user's travel and send the information to the system so that the system can compare the actual travel with the trip plan.

Once the initial trip plan is created by the system, proposed modifications or actual modifications to the trip plan can be received by the system and policy violations determined. In one embodiment, the proposed modification can be used to project policy violations that can be displayed to a user of the system or user of the user computer device. During travel, the actions or inactions of the user can generate policy violations that can be displayed on the user computer device and transmitted to the system. The system or the user computer device can display violation alerts with supporting detail. For example, the user can be presented with an alert that states that the maximum number of files for the trip will be exceeded with the trip plan modifications, the maximum number of miles on the original trip plan, the number of miles that the policy will be exceeded, the effect on the travel time, and any combination of trip plan information.

The user can view these alerts in the user computer device and as appropriate adjust the trip plan in order to remedy or mitigate any policy violations. In one embodiment, the user may mute any policy violation so that the trip modifications can be accepted and will not be displayed on the user computer device as a policy violation. For example, if a user is mid-route and a dispatcher requests that the user insert a stop into the route, the insertion of the additional stop may create a policy violation such as number of miles for the trip plan is exceeded, the time of the trip plan is exceeded or other such violations. However, if the stop is being inserted due to an urgent pick up, the policy violation could be understandably muted. Once the user starts an activity associated with a target location (e.g., beginning a route), the trip plan can be continuously monitored for policy violations caused by delays, routing changes, external force, the user or any updates to the trip plan including updates from the system. If there are policy violations during the activity, then the user can be alerted and react accordingly.

When a user is dispatched on an activity such as a trip, the trip plan can be received by the user computer device from the system. The trip plan can include a list of stops or waypoints where one or more can be associated with one or more target locations. Detailed information about each target location, the acts to be performed at the target location, the logistics of the route associated with the target location, and a set of policies to be applied to the trip plan can be included.

In one embodiment, the user computer device can detect variations from the trip plan, transmit the variations to the server and receive violation information from the server representing that the variations violate one or more policies. For example, the user computer device can detect that a driver has deviated from a route, transmit the deviation to the system, where the system can determine if the deviation violates a policy (e.g., cause the route to exceed the maximum number of miles for the trip), transmit the violation to the user computer device where the user computer device can display the violation. The driver can then determine whether to correct the violation, mute the violation alert or continue with the deviation that resulted in a policy violation. The driver may also modify the remaining trip parameters so to remove the violation (e.g., reduce the miles on another portion of the route).

In one embodiment, the policies are received by the user computer device and the determination if a policy violation can be made at the user computer device. The computer readable instructions at the user computer device can receive the original trip plan from the system, receive policies associated with the trip plan from the system, receive or detect trip plan modifications or variation before or during the trip, determine if the modification or validations violate a policy and display violations on the user computer device. The user can then modify the trip plan, modify the actual travel and activities, or mute the violation.

In one embodiment, the system or the user computer device can assess the violations and, provide recommended adjustments to the trip plan in order to minimize or avoid the violations. In one embodiment, the system can aggregate policies and violations and create routes according to past policy violations. For example, if several trip plans consistently show policy violations, such violations may be due to a closed road so that the miles of the trip are increased due to a detour. The system can use this information to create future trip plans that take into account the reasons for the series of policy violations so that future trip plans include a route that includes the detour.

The trip plan data can include the list of stops including intermediary and final target locations with detailed information about each target location, the actions or inactions associated with the target location, the geometry of the route that will be navigated to each target location, and a set of policies to be applied to the trip plan. The policy data can include policy logic and data representing the policy thresholds (e.g., policy data can include a maximum total trip miles representing the maximum number of miles for the trip and the logic to be used in applying the policy to the trip). The trip plan data can be validated and forwarded by the server to a user computer device. The user computer device can compute the route for navigation to each target location, apply policies to the trip plan, and send the trip plan data, along with any policy violations to the system or a third-party computer system. The system can receive information concerning a trip or route segment for the entire trip or route. The system can receive user input/information concerning a leg or segment for the entire trip or route as well. The user can access the policy violations using the user computer device and, if possible, adjust the trip plan in response to the violation. The user computer device can also send the violations to the system, which can assess the violations and, if possible, adjust the trip plan accordingly or offer suggestions to the user for adjusting the trip plan or route. The user computer device can continuously monitor the trip plan throughout the duration of the trip and if any policy violations occur, respond accordingly.

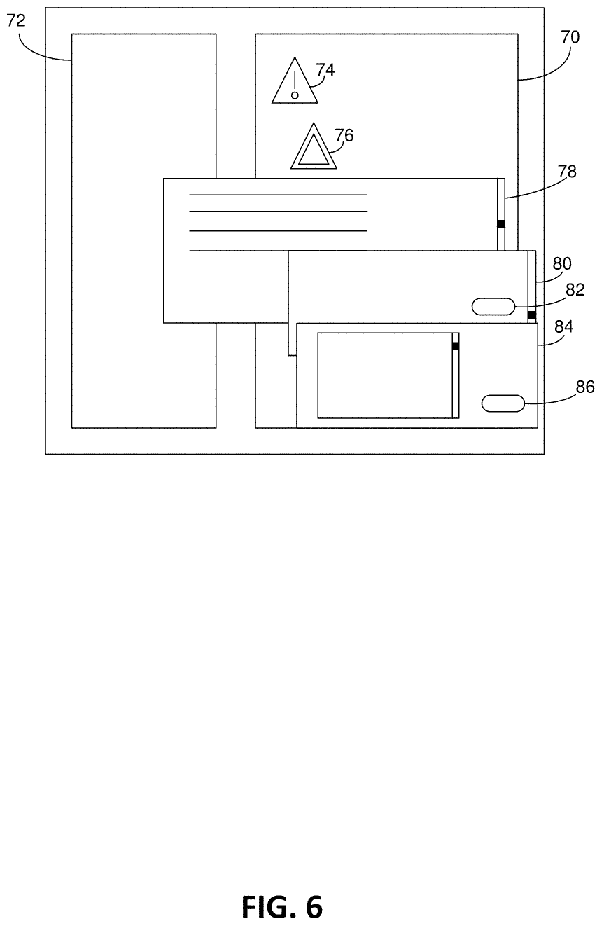

Referring to FIG. 5, the proposed, initial, or original trip plan or components thereof can be received by the system at 50. The trip plan can be accompanied by performance attributes and policies. In one embodiment, the system can create policies according to the performance attributes. For example, a trip's attributes can include a maximum fuel cost. The system can receive or retrieve fuel efficiency information associated with the user, receive, or retrieve fuel cost information and determine a maximum number of miles for the trip so as not to exceed the maximum fuel costs. The initial trip plan can be transmitted to a user computer device. The user computer device can be used to enter proposed modifications to the trip plan prior to or during the trip. The user computer device can detect modifications to the trip plan that occur during the trip. The system or user computer device can determine if modifications to the trip plan have occurred at 52. If modifications to the trip plan have occurred, the system or user computer device can retrieve polices associated with the trip at 54. The system or user computer device can analyze the modifications at 56 and analyze the modifications according the policies and performance attributes at 56. If a violation is determined at 58, the violation type can be determined at 60 and the violation transmitted to the user computer device at 62.

Violation types can include various levels of violation identifiers such as a warning level and a critical level. A warning level could represent that the modification to the trip has a likelihood that a policy will be violated if the modifications are made. A warning level could indicate that the modification places violations on the policy with a certain range or percentage that would not be considered critical according to the performance attributes. A critical level violation could be a violation that is unacceptable according to the performance attributes.

Once the violation alert is presented to the user, the user may have the option to mute the violation alert at 64. In one embodiment, the user can mute the violation alert, provide a reason to mute (e.g., ignore) the violation at 66 and continue with the trip plan with the modification. The action of muting the violation alert and the reason can be sent to the system at 68. For example, if the route includes the use of a certain road and the road is closed, the user will have to re-route to another road. The re-route could result in a violation. Because the re-route is necessary and unavoidable, muting the violation alert and accepting the re-route allows the target location to be reached. The mute and the reason for the mute can be transmitted to the server so that when future trip plans are created, the closed road is considered and not included in the future route.

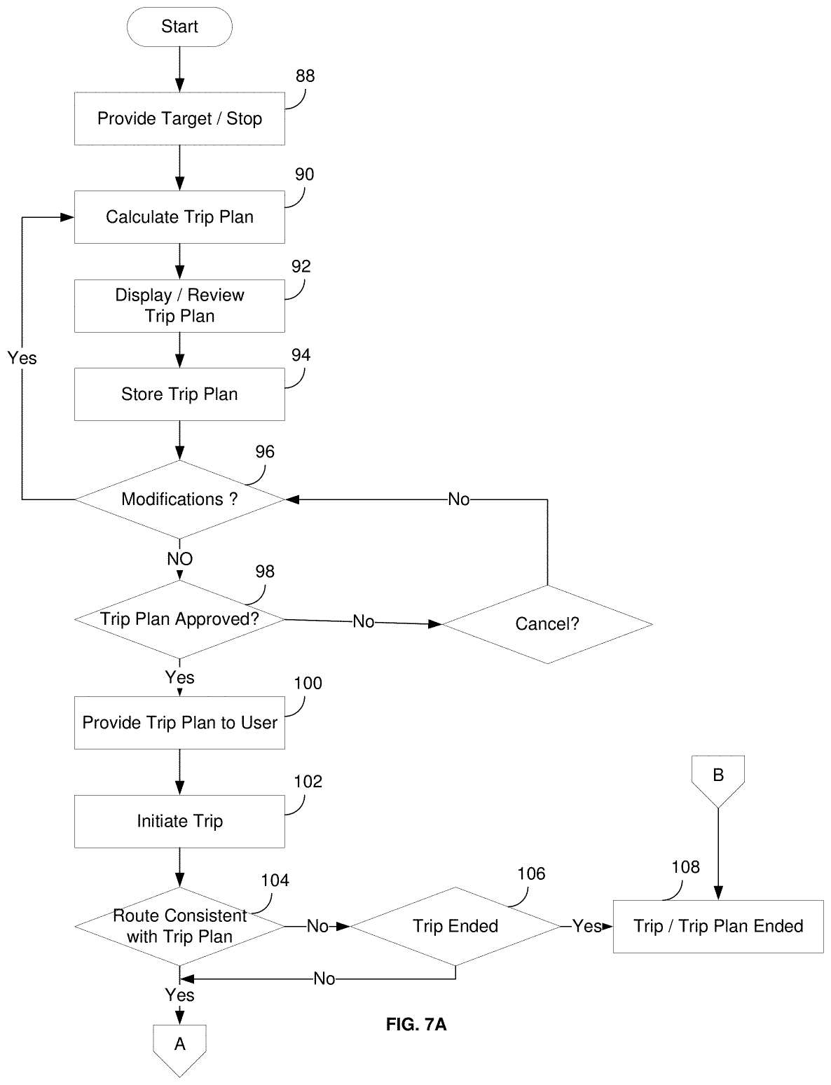

Referring to FIG. 6, a display on the user computer device can include a map area 70 and a trip information area 72. If a policy violation is present, a first alert indicator 74 can be displayed on the user computer device. The first alert indicator can include a color or symbol showing that it is a policy violation that is not muted and/or critical. A second alert indicator 76 can be displayed indicating that a policy violation exists, but the violation has been muted. The second indicator can be of a different color or symbol. In one embodiment, if the indicator is actuated, a violation alert area 78 can be displayed that can show one or more violation alert, the violation type, if muted or unmuted and provide the user with the ability to actuate a mute area. The violation alert area can include segments for critical, warnings, muted and other violation types. If a violation occurs and a violation alert is actuated, the screen can provide further detail about that violation in a detail screen 80. The detail screen can allow the user to mute the violation alert by actuating a button 82. The user can enter the reason for the mute in screen 84 and transmit the information by actuating button 86.

By way of a non-limited example, a user may wish to limit a trip to a length of 560 miles. A policy called “Max Miles” with an identifier of “max-miles” can be stored on the server along with computer readable instructions that compare the total miles of the trip with the policy that is the maximum miles allowed. When the user begins the trip, there would be no policy violations. If the user modified the trip plan to include an additional stop, the addition may cause the total miles to exceed 560 and causes a violation. If the stop is a necessary stop, the user can access the violation screen, select the violation, mute the violation and provide an explanation of the violation being muted.

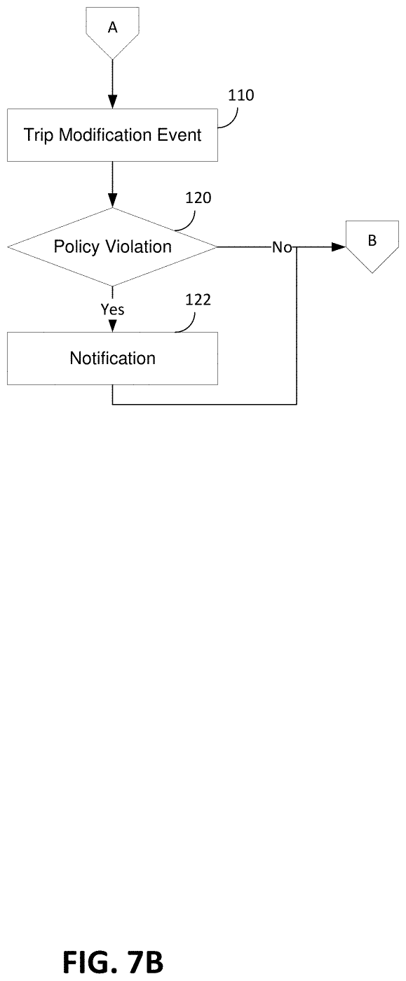

Referring to FIGS. 7A and 7B, in one embodiment, an operator can provide one or more target locations that can include one or more stops to the system at 88. In the event that the operator provides only one target location, the system can calculate a route from a departure location to the target location. The system can determine the current location of a user and use that information as the departure location. The system can calculate a trip plan at 90 from the departure point to the target location and if stops are provided, include the stops in the trip plan. The trip plan can be associated with a user so that each user (e.g., driver) can be uniquely associated with a trip plan. A trip plan can also be assigned to a first user and subsequently assigned to a second user. The trip plan can be stored at 94 and include calculations for hazards, travel conditions, policies and any combination. The trip plan can be stored for subsequent review by the system as well as transmitted to a customer for the customers use and storage. The trip plan can be unique for each departure location and target location based upon a date and time stamp. The operator can review the trip plan at 92 and make modifications at 94 to the trip plan. If modifications are made, the system can calculate another trip plan by returning to 90. If the trip plan is approved at 98, the trip plan can be provided to the user at 100. The user can receive a notification that a trip plan is available and access the system to retrieve the trip plan, or the trip plan can be transmitted to a user computer device automatically. The user can then begin the trip at 102.

During the route associated with trip, the system or user computer device can receive information concerning the travel route and determine if the user's travel route is consistent with the trip plan at 104. If the trip route is consistent with the trip plan, the system can determine if the trip is concluded at 106 and if so, the trip plan can be ended and stored. If the trip route deviates from the trip plan, or the operator or user request a modification to the trip plan, the trip plan can be modified at 110. Modifications to the trip plan occur for any number of reasons including road conditions, road inaccessibility or closures, adding stops, removing stops, equipment failures or inoperability (e.g., vehicle break downs), stop delays, change in policies and any combination. If a trip plan is modified, or if a modification is requested, the system can determine if the modification creates a policy violation at 112 and if so, notify the operator, user or third-party. The modified trip plan can be accepted with or without policy violations (e.g., policy violation muted) at 114 and the trip can continue to be implemented until the trip is concluded. The trip plan, route, and/or modifications can each be recorded and stored for subsequent retrieval by the system including the server and user computer device.

The one or more computer executable program code portions may also be loaded onto a computer device and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those skilled in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A computerized system for trip management comprising:
a route system having a computer readable medium and in communications with a dispatcher computer system and a user computer device; and,
a set of route computer readable instructions included in the route system configured for:
receiving trip information from a dispatch computer system including an origin, target location and a policy wherein the policy is taken from the group consisting of maximum miles, earliest arrival time, latest arrival time, target location information, and any combination thereof,
calculating a route between the origin and target location according to the policy so that a first policy violation is not present,
creating a trip plan according to the trip information and the route,
receiving a proposed trip plan modification,
determining if the proposed trip plan modification results in a second policy violation,
transmitting a policy violation alert to the user computer device if the second policy violation is determined,
receiving a second policy violation mute request, and,
muting the second policy violation alert.

2. The computerized system of claim 1 wherein the route system is in communication with a third-party computer system and the set of route computer readable instructions include instructions configured for creating a trip plan configured to be displayed on a map generated by the third-party computer system.

3. The computerized system of claim 1 wherein the set of route computer readable instructions include instructions configured for receiving a user location from the user computer device, comparing the user location with the trip plan, and, determining if there is a deviation from the trip plan.

4. The computerized system of claim 3 wherein the set of route computer readable instructions include instructions configured for determining if the deviation creates a deviation policy violation.

5. The computerized system of claim 4 wherein the set of route computer readable instructions include instructions configured for transmitting the deviation policy violation to one of the route system, the dispatcher computer system, and a combination thereof.

6. The computerized system of claim 4 wherein the set of route computer readable instructions include instructions configured for receiving the proposed trip plan modification from the user computer device.

7. The computerized system of claim 1 including a set of user computer readable instructions for receiving a mid-trip trip plan modification and determining if the mid-trip trip plan modification results in a mid-trip policy violation

8. The computerized system of claim 7 wherein the set of user computer readable instructions include instructions for creating a mid-trip policy alert representing a mid-trip policy violation.

9. The computerized system of claim 8 wherein the set of user computer readable instructions include instructions for muting the mid-trip policy alert.

10. The computerized system of claim 8 wherein the set of user computer readable instructions include instructions for modifying the trip plan according to the mid-trip trip plan modification.

11. The computerized system of claim 1 wherein the set of route computer readable instructions include instructions configured for transmitting the trip plan to the user computer device.

12. The computerized system of claim 11 wherein the set of route computer readable instructions include instructions configured for receiving a trip plan approval prior to sending the trip plan to the user computer device.

13. The computerized system of claim 12 wherein the set of route computer readable instructions include instructions configured for receiving the trip plan approval from the dispatch computer system.

14. The computerized system of claim 1 wherein the set of route computer readable instructions include instructions configured for creating the trip plan according to a prior trip plan having a same target location.

15. The computerized system of claim 1 wherein the set of route computer readable instructions include instructions configured for receiving a mute reason when the second policy violation alert is muted.

16. A computerized system for trip management comprising:
a route system having a computer readable medium and in communications with a user computer device; and,
a set of route computer readable instructions included in the route system configured for:
receiving trip information including an origin, target location and a policy,
calculating a route between the origin and target location according to the policy,
creating a trip plan according to the trip information and the route,
receiving a proposed trip plan modification,
determining if the proposed trip plan modification results in a policy violation, and,
transmitting a policy violation alert to the user computer device according to the policy violation.

17. The computerized system of claim 16 wherein the set of route computer readable instructions include instructions configured for muting the policy violation alert.

18. The computerized system of claim 17 wherein the set of route computer readable instructions include instructions configured for muting the policy violation alert is the policy violation is a non-critical policy violation.

19. A computerized system for trip management comprising:
a route system having a computer readable medium and in communications with a user computer device; and,
a set of route computer readable instructions included in the route system configured for:
receiving trip information including a target location and a policy,
creating a trip plan according to the trip information,
receiving a proposed trip plan modification,
determining if the proposed trip plan modification results in a policy violation, and,
transmitting a policy violation alert to the user computer device according to the policy violation.

20. The computerized system of claim 19 wherein the set of route computer readable instructions include instructions configured for receiving location information from the user computer device, determining if there is a deviation from the trip plan and determining if the deviation creates a deviation policy violation.
